(19) United States
(12) Patent Application Publication
(10) Pub. No.: US 2021/0059891 A1
(43) Pub. Date: Mar. 4, 2021

(54) Electric Vehicle

(71) Applicant: Suzuki Motor Corporation, Hamamatsu-shi (JP)

(72) Inventors: Gopinath Raja, Hamamatsu-shi (JP); Masayoshi Wada, Hamamatsu-shi (JP)

(73) Assignee: Suzuki Motor Corporation, Hamamatsu-shi (JP)

(21) Appl. No.: 16/922,441

(22) Filed: Jul. 7, 2020

(30) Foreign Application Priority Data
Aug. 27, 2019 (JP) 2019-154786

(51) Int. Cl. A61H 3/04; B60N 2/04; B60K 1/00; B60K 35/00; B60L 15/20; B60K 26/02; B62D 51/04

(52) U.S. Cl. CPC A61H 3/04; B60N 2/04; B60K 1/00; B60K 35/00; B60L 15/20; A61G 5/04; B62D 51/04; B60K 2026/025; B60K 2370/152; B60K 2370/171; B60K 2370/172; B60K 26/02

(57) ABSTRACT

There is provided a moving base which includes a front base with front wheels and a rear base with rear wheels, the front and rear base extendable in a front-rear direction of a vehicle; a seat movable between a seating position and a folded position; a motor which drives the front and/or rear wheel; a sensor which detects the seating position and the folded position; a display part for displaying information related to the seating position or the folded position detected by the sensor to a user; and a control unit which controls the motor in accordance with operation of an operating part, and which can execute control such that a driving operation of the motor by the operating part is disabled when the sensor does not detect the seating or folded position.

### TECHNICAL FIELD

The present invention relates to an electric vehicle, and more particularly, relates to a small electric vehicle which can be also used as an electric walking aid vehicle.

### BACKGROUND ART

Conventionally, as a vehicle for a user carrying a burden when walking, a small electric vehicle such as an electric wheelchair or an electric walking aid vehicle of the cart type has been used. For example, Patent Literature 1 discloses an electric vehicle having a walking mode in which a caregiver or the like operates the vehicle while walking in a state in which a user is seated, in addition to a mode in which the user operates the vehicle while the user is seated on the vehicle. However, in this electric vehicle, use as an electric walking aid vehicle in which the user operates the vehicle has not been considered.

### CITATION LIST

### Patent Literature

[Patent Literature 1] JP 2002-233007 A

### DISCLOSURE OF THE INVENTION

### Problem to be Solved by the Invention

A small electric vehicle has a seat, and thus has a longer wheelbase compared to electric walking aid vehicles, so that handling is poor for use as an electric walking aid vehicle. Preferably, an electric walking aid vehicle has a short vehicle length and a small turning radius. Accordingly, the inventors have developed an electric vehicle having a vehicle body which is extendable to the front and rear and a foldable seat to be suitable for use in a small electric vehicle mode and an electric walking aid vehicle mode.

In this electric vehicle, an operation of an operating part is disabled since the operation while switching of the small electric vehicle mode and the electric walking aid vehicle mode is not suitable for running. However, if completion of switching cannot be clearly grasped by a user, convenience of mode switching may be deteriorated.

The present invention is made considering this point, and an object of the present invention is to allow the user to clearly grasp switching of the small electric vehicle mode and the electric walking aid vehicle mode.

### Means for Solving the Problem

In order to solve the problem, an electric vehicle according to the present invention includes:

a moving base which includes a front base with front wheels and a rear base with rear wheels, the front base and the rear base being connected to be extendable in a front-rear direction of a vehicle;

a seat configured to be movable between a seating position and a folded position on the moving base mechanically working with an expansion and contraction operation of the front base and the rear base;

a motor which drives the front wheel and/or the rear wheel;

a sensor which detects the seating position and the folded position;

a display part having a function of displaying information related to the seating position or the folded position detected by the sensor to a user; and

a control unit which controls the motor in accordance with an operation of an operating part, and which can execute control such that a driving operation of the motor by the operating part is disabled when the sensor does not detect the seating position or the folded position.

### Advantageous Effect of Invention

As described above, in the electric vehicle according to the present invention, the sensor which detects the seating position and the folded position is provided and the display part having a function of displaying information related to the seating position or the folded position detected by the sensor to a user is provided. Accordingly, the user can clearly grasp switching of the small electric vehicle mode and the electric walking aid vehicle mode, and can enjoy the convenience of mode switching.

### BRIEF DESCRIPTION OF DRAWINGS

FIG. 1 is a side view showing an electric vehicle according to an embodiment of the present invention.

FIG. 2 is a front view showing the electric vehicle according to the embodiment of the present invention in which a lower portion is omitted.

FIG. 3 is a perspective view of an operating part of the electric vehicle according to the embodiment of the present invention seen from diagonally upper rearward.

FIG. 4 is a block diagram showing a control system of the electric vehicle according to the embodiment of the present invention.

### MODE FOR CARRYING OUT THE INVENTION

Hereinafter, an embodiment of the present invention will be explained in detail with reference to the drawings.

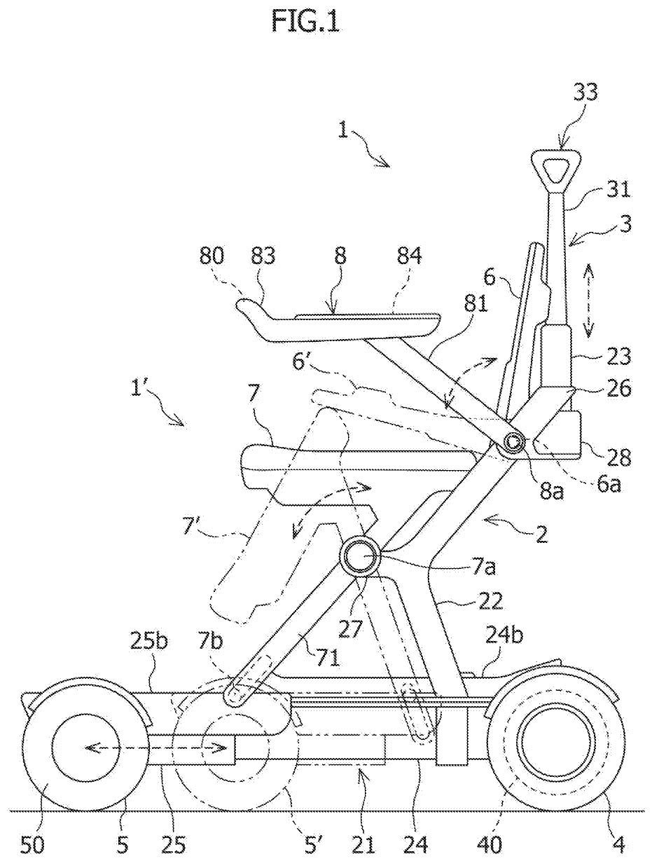

In FIG. 1, an electric vehicle 1 according to the embodiment of the present invention includes a vehicle body 2 constituted by a moving base 21 (a lower carrier) and an upper frame 22 provided to stand at the rear of the moving base 21 (a rear base 24), and can be used in a small electric vehicle mode (1) shown in solid lines in FIG. 1 and an electric walking aid vehicle mode (1′) shown in phantom lines in FIG. 1.

The moving base 21 includes a rear base 24 (a main body portion) to which right and left rear wheels 4 (a drive wheel) and the upper frame 22 are provided and a front base 25 to which right and left front wheels 5 (a driven wheel) are provided, and the front base 25 is slidably coupled in a front-rear direction at a front side of the rear base 24 and the moving base 21 is constituted such that a wheelbase is extendable.

The right and left rear wheels 4 are independently driven by right and left motors 40 (40L, 40R) mounted to the rear base 24. The right and left front wheels 5 are constituted by an omni wheel (an omnidirectional wheel) including a number of rollers 50 which are rotatable about a circumferential axis at a grounding part. Moreover, steering and drive control operation of the electric vehicle 1 can be performed only by the control of the motors 40L, 40R by an operating part 83 (a seat operating part) or rear operating parts 33, which will be explained later.

The upper frame 22 has an inverse U-shape or portal shape in which upper ends of a right and left pair of frames (side frames) provided upward from both right and left side portions of the rear base 24 are coupled by an upper end frame 26 extending in a vehicle width direction, and a rear cover frame 28 is arranged to extend in the vehicle width direction having a gap at a lower side of the upper end frame 26. Moreover, a stem supporting portion 23 penetrating through the upper end frame 26 to extend upward is provided at a center in a width direction of the upper end frame 26 and the rear cover frame 28.

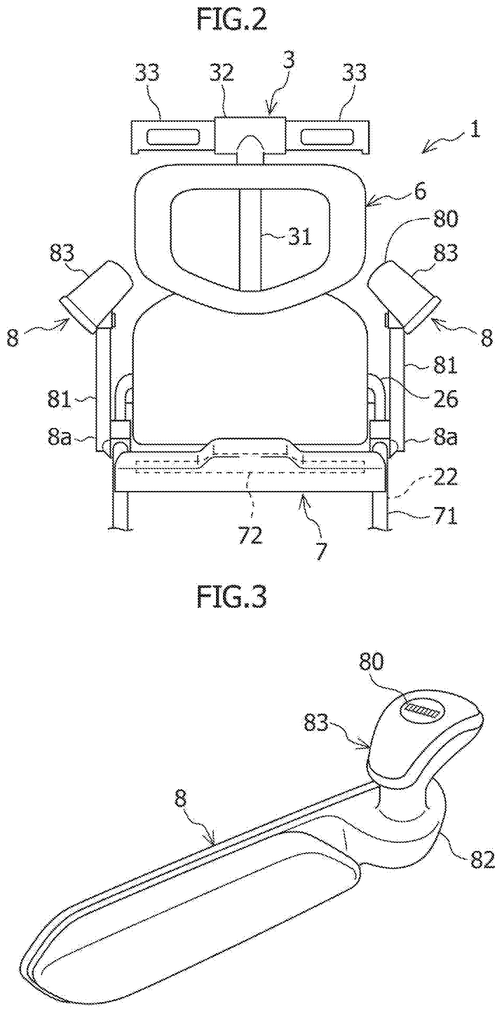

The stem supporting portion 23 has a hollow cylindrical shape in which a lower end portion of a stem 31 of a rear handle 3 is slidably supported in an upper and lower direction and fixed by not shown locking means with an adjustable height. As shown in FIG. 2, the rear handle 3 has a T-bar shape having a pair of rear operating parts 33 extending to the right and left from a connecting portion 32 with an upper end of the stem 31. These rear operating parts 33 are an operating part in a case in which a user uses it in the electric walking aid vehicle mode, and in a case in which a caregiver or the like operates the electric vehicle in a state in which the user is seated on seat 7.

In the upper frame 22, a lower end portion of a seat back 6 (6a), a leg portion 71 of the seat 7 (a seat cushion) (7a) and a base portion of the arm rest 8 (8a) are all pivotally supported by axes 6a, 7a, 8a which are parallel to the vehicle width direction, while a lower end of the leg portion 71 is pivotally and slidably coupled to the front base 25 (pin) via a coupling portion 7b (a slot.)

With the above configuration, when the seat 7 is pivoted forwardly downward to be moved to a folded position 7′ as shown in the phantom lines in the figures from the small electric vehicle mode shown in solid lines in the figures, the front base 25 is slid rearward and the moving base is shortened, which causes the electric walking aid vehicle mode in which the user can operate by the rear operating parts 33 while standing and walking.

In this case, when the seat back 6 is inclined forward to move to a folded position 6′, an upper surface (a rear surface) of the seat back 6′ can be used as a mounting space for packages, and the arm rest 8 can be used as an anti-drop guard of the mounted packages. Also, upper surfaces 24b, 25b of the rear base 24 and the front base 25 can be used as a tray for mounting packages.

Also, in the electric walking aid vehicle mode shown in the phantom lines in the figures, the seat back 6′ is raised to return to a seating position 6 and then the seat 7′ is pivoted rearward to return to a seating position 7, as shown in the solid lines in the figures, the front base 25 is slid forward and the moving base 21 is extended, which causes the small electric vehicle mode in which the user is seated at the seat 7 to be capable of free-running by an operation of the operating part 83 of the arm rest 8.

As shown in FIG. 3, the operating part 83 is provided at a tip portion 82 of the arm rest 8, and is constituted by a handle or a joystick extending forward and upward diagonally from the tip portion 82. The operating part 83 may be an operating part with a system in which the right and left motors 40L, 40R are allocated to the right and left handles to execute forward movement, backward movement, right and left rotation and pivot turn, or an operating part with a joystick system in which either of the right and left handles executes forward movement, backward movement and right and left rotation, and moreover, a display part 80 for displaying a variety of information is provided at a tip portion of one (or both) of the operating parts 33.

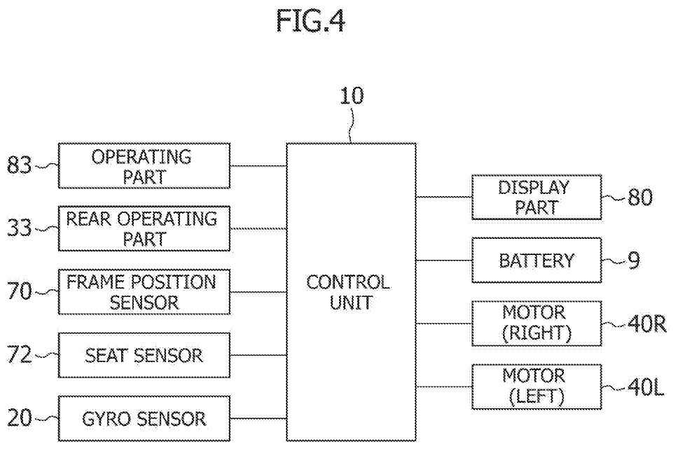

FIG. 4 is a block diagram showing a control system of the electric vehicle. To a control unit 10, in addition to an operating input from the operating part 83 of the arm rest 8 and the rear operating parts 33, a variety of types of information, such as seating/folded position information detected by a frame position sensor 70, passenger information detected by a seat sensor 72, vehicle attitude information such as an acceleration rate or inclination detected by a gyro sensor 20 and a remaining amount of a battery 9 (state of charge, SOC) is input and displayed on the display part 80.

The frame position sensor 70 is constituted by a contact type/non-contact type sensor, a switch and the like provided at each side end of a moving range in order to detect a pivot position of a pivot support portion 7a of the seat 7 (a leg portion 71) to a frame-side mounting portion 27, a position of the front base 25 to a coupling portion 7b at a lower end of the leg portion 71 or a sliding position of the front base 25 to the rear base 24, and detects seating/folded position information of the seat 7.

In the control unit 10, when the seating position of the seat 7 is detected by the frame position sensor 70 and seating of the user is detected by the seat sensor 72, an operation of the operating part 83 of the arm rest 8 is enabled, and a “free-running mode” is displayed on the display part 80. Also, in this state, when moving to an “assisted running mode” with the user on board is performed due to an operation from the rear operating parts 33, the “assisted running mode” is displayed on the display part 80. When the seating position of the seat 7 is not detected by the frame position sensor 70, an operation of the operating part 83 is disabled.

On the other hand, when the folded position of the seat 7 is detected by the frame position sensor 70, an operation of the rear operating parts 33 is enabled, and a “walking aid mode” is displayed on the display part 80. Additionally, when the seat 7 is positioned at the middle of the seating/folded position and neither the seating position nor the folded position is detected by the frame position sensor 70, an operation of the operating part 83 of the arm rest 8 and an operation of the rear operating parts 33 are disabled, and the display part 80 displays that the seat 7 is moving. In this case, a warning such as flashing of a screen or a buzzer may also be used.

When the electric vehicle 1 is activated and setup of the control unit 10 is completed, a remaining amount of a battery is displayed on the display part 80. Also, when any of the seating/folded position is detected by the frame position sensor 70, a remaining amount of the battery is displayed on the display part 80, which allows the user to confirm that transformation of the frame is completed thereby.

Additionally, as the display part 80, one constituting a light emitting unit such as an LED, an LCD and an OLED is preferable. Also, the display part 80 may be arranged at a surface 84 of the arm rest 8 or an arm portion 81 of the arm rest 8 other than a top surface of the operating part 83. The top surface of the operating part 83 or the surface 84 of the arm rest 8 can be easily seen also from the rear operating parts 33.

Additionally, while a case in which the omni wheel is used as the front wheel 5 is shown in the above embodiment, a driven wheel steerably supported by a caster system or the like may be used.

As described above, while the embodiment of the present invention has been explained, the present invention is not limited to the above embodiment, and additionally, various modifications and changes may be performed based on the technical concept of the present invention.

### REFERENCE SIGNS LIST

1 Electric vehicle
2 Vehicle body
3 Rear handle
4 Rear wheel
5 Front wheel
6 Seat back
7 Seat
8 Arm rest
10 Control unit
21 Moving base
22 Upper frame
23 Stem supporting portion
24 Rear base
25 Front base
26 Upper end frame
28 Rear cover frame
31 Stem
33 Rear operating part
40 Motor
80 Display part
70 Frame position sensor
72 Seat sensor
83 Operating part

1. An electric vehicle comprising:
a moving base which includes a front base with front wheels and a rear base with rear wheels, the front base and the rear base being connected to be extendable in a front-rear direction of a vehicle;
a seat configured to be movable between a seating position and a folded position on the moving base mechanically working with an expansion and contraction operation of the front base and the rear base;
a motor which drives the front wheel and/or the rear wheel;
a sensor which detects the seating position and the folded position;
a display part having a function of displaying information related to the seating position or the folded position detected by the sensor to a user; and
a control unit which controls the motor in accordance with an operation of an operating part, and which can execute control such that a driving operation of the motor by the operating part is disabled when the sensor does not detect the seating position or the folded position.

2. The electric vehicle according to claim 1, wherein the front base and the rear base are slidably connected in the front-rear direction of the vehicle,
the seat is pivotally supported around an axis in a vehicle width direction by an upper frame of the rear base, and a leg portion extending downward exceeding a pivot support portion of the seat is connected to the front base pivotally and slidably,
the seat is configured to be in the seating position at an extended position of the moving base in which the front base and the leg portion are positioned at a side away from the rear base, and the seat is in the folded position inclining forward at a shortened position of the moving base in which the front base and the leg portion are positioned at a side of the rear base.

3. The electric vehicle according to claim 1, wherein the display part includes a first display mode for displaying the information related to the seating position or the folded position and a second display mode for displaying a driving operation by the operating part during the first display mode, and the second display mode includes a display that the control unit makes the driving operation by the operating part disabled.

4. The electric vehicle according to claim 3, wherein the display part further comprises a third display mode for displaying a state of charge of a battery.

5. The electric vehicle according to claim 1, wherein the sensor is arranged to detect a phase of a mechanical linkage portion of the seat and the moving base corresponding to the seating position and the folded position and/or a phase at a movable supporting portion of the seat corresponding to the seating position and the folded position.

6. The electric vehicle according to claim 1, wherein the operating part includes a seat operating part configured to be operable by a user seated at the seat and a rear operating part configured to be operable by the user in a standing and walking attitude from behind the seat, and
the control unit can execute control such that an operation of the seat operating part is enabled when the sensor detects the seating position, while an operation of the rear operating part is enabled when the sensor detects the folded position.
